(19) United States
(12) Patent Application Publication
(10) Pub. No.: US 2026/0319511 A1
(43) Pub. Date: Oct. 15, 2026

(54) METHOD AND APPARATUS FOR PLANNING REFERENCE LOCAL PATH ON LOCAL SEMANTIC NAVIGATION MAP FOR LOW-COST SENSOR-BASED AUTONOMOUS DRIVING

(71) Applicant: NEUBILITY INC., Seoul (KR)

(72) Inventors: Tae Won KANG, Seoul (KR); Sung Woo CHO, Seoul (KR); Chang Hyeon PARK, Seoul (KR); Kee Hyuk KANG, Seoul (KR)

(21) Appl. No.: 18/704,195

(22) PCT Filed: May 25, 2023
(86) PCT No.: PCT/KR2023/007153

§ 371 Date: Apr. 24, 2024

(30) Foreign Application Priority Data
Apr. 12, 2023 (KR) 10-2023-0047924

(51) Int. Cl. G05D 1/644; G05D 1/246; G05D 107/13; G05D 109/10

(52) U.S. Cl. CPC G05D 1/644; G05D 1/246; G05D 2107/13; G05D 2109/10

(57) ABSTRACT

The present disclosure relates to a method and an apparatus for planning a reference local path in a local semantic navigation map. The method includes extracting a travel area recognized from travel information matched with location information of a robot in a local semantic navigation map (LSN) and vision information of the robot, extracting at least one candidate path using the extracted travel area or a robot's location information-based global path, determining reliability of each candidate path by calculating a reliability cost of each of the extracted at least one candidate path, and deriving a candidate path with the highest reliability among the determined at least one candidate path as the reference local path and setting the derived reference local path as a target section of the robot.

### TECHNICAL FIELD

The present disclosure relates to a method and an apparatus for planning a local path, and more particularly, to a method and an apparatus for planning a reference local path in a local semantic navigation map.

### BACKGROUND ART

Recently, with a development of an autonomous driving technology, autonomous driving using various platforms such as a vehicle, an aircraft, a drone, a robot, and a ship is being attempted.

To precisely control a movement of a four-wheeled mobile robot, it is important to robustly handle many risks arising from a surrounding environment. In the case of autonomous driving of the vehicle, because the vehicle mainly travels on a roadway, obstacles and travel areas are regular. On the other hand, an outdoor delivery robot travels on a sidewalk, a crosswalk, an indoor space, and the like where there are more complex and diverse obstacles. Therefore, it is necessary to handle various travelable areas encountered in a robot's route based on a semantic navigation map, and to handle an area where location information is shaded.

In a case of a map using global navigation satellite system (GNSS) information used in the outdoor autonomous driving of the delivery robot, a situation in which a type of travelable area changes and a range of the travelable area also changes occurs depending on the route in local coordinates. In this case, when the location information is very accurate or when the location information is very accurate and there is no human error in constructing the map, any situation may be handled. However, it is necessary to travel using sensing results in which vision sensor information are accumulated in case the location information is shaded, such as in a situation in which tall buildings are crowded together or the Internet is not working well. Additionally, a camera-based autonomous driving system must also be able to handle low-accuracy vision sensor information.

A recognition performance of a sensor may deteriorate while the mobile robot is traveling. When features other than a label in the navigation map are features that have not been learned, the overall recognition performance of the vision sensor may deteriorate, so that derivation of a travel path may be inaccurate.

Further, when a global path is far from the local coordinates, an error may occur in location selection of the mobile robot. When creating the global path, because a user selects a node of the delivery robot, a human error may occur. Additionally, the error may occur at any time on the location information, which may lead to sudden location shifting. Additionally, when the location information of the mobile robot is not available, it is difficult to identify a current location of the robot. As such, the derivation of the travel path may be inaccurate because of lack of the recognition performance using the location information of the mobile robot or the vision information.

### DISCLOSURE

### Technical Purpose

Embodiments of the present disclosure are to provide a method and an apparatus for planning a reference local path in a local semantic navigation map that extract the reference local path using the local semantic navigation map (LSN) to compensate for a poor performance of recognition using location information and vision information.

However, the problems that the present disclosure aims to solve are not limited to those, and are able to be expanded in various ways in environments that do not deviate from the idea and scope of the present disclosure.

### Technical Solution

According to an embodiment of the present disclosure, there is provided a method for planning a reference local path in a local semantic navigation map performed by a reference local path planning apparatus, the method including: extracting a travel area recognized from travel information matched with location information of a robot in a local semantic navigation map (LSN) and vision information of the robot; extracting at least one candidate path using the extracted travel area or a robot's location information-based global path; determining reliability of each candidate path by calculating a reliability cost of each of the extracted at least one candidate path; and deriving a candidate path with the highest reliability among the determined at least one candidate path as the reference local path and setting the derived reference local path as a target section of the robot.

In one embodiment, the method may further include updating the navigation map using labeled local semantic information that has not been integrated.

In one embodiment, the extracting of the candidate path may include extracting the candidate path while maintaining tendency of the global path close to local coordinates of the robot.

In one embodiment, the extracting of the candidate path may include extracting the respective candidate paths for both edges and a central portion from the extracted travel area.

In one embodiment, the extracting of the candidate path may include extracting the candidate path from the robot when the extracted candidate path has the number of used points smaller than a preset threshold number or has a distance from the robot greater than a preset threshold distance.

In one embodiment, the determining of the reliability of each candidate path may include weighting the reliability cost for each of the extracted at least one candidate path based on the number of points used to extract each of the at least one candidate path.

In one embodiment, the determining of the reliability of each candidate path may include weighting the reliability cost for each of the extracted at least one candidate path based on a distance from the robot.

In one embodiment, the method may further include deriving the reference local path using the location information of the robot and the global path when the determined reliability of the at least one candidate path is smaller than a preset threshold.

According to another embodiment of the present disclosure, there is provided an apparatus for planning a reference local path in a local semantic navigation map, the apparatus including: a memory that stores one or more programs, and a processor that executes the one or more stored programs, and the processor extracts a travel area recognized from travel information matched with location information of a robot in the local semantic navigation map and vision information of the robot, extracts at least one candidate path using the extracted travel area or a robot's location information-based global path, determines reliability of each candidate path by calculating a reliability cost of each of the extracted at least one candidate path, and derives a candidate path with the highest reliability among the determined at least one candidate path as the reference local path and set the derived reference local path as a target section of the robot.

In one embodiment, the processor may update the navigation map using labeled local semantic information that has not been integrated.

In one embodiment, the processor may extract the candidate path while maintaining tendency of the global path close to local coordinates of the robot.

In one embodiment, the processor may extract the respective candidate paths for both edges and a central portion from the extracted travel area.

In one embodiment, the processor may extract the candidate path from the robot when the extracted candidate path has the number of used points smaller than a preset threshold number or has a distance from the robot greater than a preset threshold distance.

In one embodiment, the processor may weight the reliability cost for each of the extracted at least one candidate path based on the number of points used to extract each of the at least one candidate path.

In one embodiment, the processor may weight the reliability cost for each of the extracted at least one candidate path based on a distance from the robot.

In one embodiment, the processor may derive the reference local path using the location information of the robot and the global path when the determined reliability of the at least one candidate path is smaller than a preset threshold.

### Advantageous Effects

The disclosed technology may have following effects. However, because it does not mean that a specific embodiment should include all of the following effects or only the following effects, the scope of rights of the disclosed technology should not be understood as being limited thereby.

The embodiments of the present disclosure may compensate for the poor performance of recognition using the location information and the vision information by extracting the reference local path using the local semantic navigation map (LSN map).

The embodiments of the present disclosure may extract the reference local path using the data extracted via the local sensor of the mobile robot, thereby performing robust and continuous lateral control of the mobile robot in a safer and more continuous manner than the scheme of extracting and controlling the reference local path only via the location information processed via the global sensor such as the global positioning system (GPS), the inertial measurement unit (IMU), and the like.

In travel using only the location information, it is difficult to achieve high accuracy in an urban area with tall and dense buildings or surrounded by glass wall. When the location is inaccurate with the location error to a level of tens of centimeters or several meters, it is difficult to control the travel with safe and smooth movement. Additionally, because the vision sensor information is a probabilistic result, it is difficult to always expect high-accuracy recognition results, and in low-accuracy recognition results, the travelable area becomes wider or narrower than it actually is. This also makes it difficult to travel safe because the recognition results are unreliable, so that the reference local path should be derived using extra sensors. The embodiments of the present disclosure may solve the above problems and enable the robust and smooth travel control even in the specific urban area or with the occasionally derived low-accuracy recognition results. As such, the embodiments of the present disclosure may perform the general-purpose autonomous driving that does not depend on the high-accuracy location information and the recognition results.

The embodiments of the present disclosure may derive the reference local path using the vision information recognized via the information obtained from the vision sensor relatively inexpensive compared to the Lidar and the location information obtained via the low-cost GPS and IMU, thereby reducing the unit cost of the mobile robot.

### DESCRIPTION OF DRAWINGS

FIG. 1 is a diagram illustrating a reference local path planning operation in a mobile robot in which an apparatus for planning a reference local path in a local semantic navigation map is implemented, according to an embodiment of the present disclosure.

FIG. 2 is a flowchart of a method for planning a reference local path in a local semantic navigation map, according to an embodiment of the present disclosure.

FIG. 3 is a diagram for illustrating an operation of deriving a reference local path in a local semantic navigation map, according to an embodiment of the present disclosure.

FIG. 4 is a diagram illustrating a recognition performance evaluation method when a type is matched at a specific location while a mobile robot is traveling in an embodiment of the present disclosure.

FIGS. 5 to 8 are diagrams showing a process example of a method for planning a reference local path in a local semantic navigation map, according to an embodiment of the present disclosure.

FIG. 9 is a configuration diagram of an apparatus for planning a reference local path in a local semantic navigation map, according to an embodiment of the present disclosure.

### BEST MODE

The present disclosure may be subject to various changes and may have various embodiments, so that specific embodiments are to be illustrated in the drawings and described in detail in the detailed description. However, this is not intended to limit the present disclosure to the specific embodiments, and it may be understood that all changes, equivalents, or substitutes included in the technical idea and scope of the present disclosure are included. In describing the present disclosure, when it is determined that a detailed description of the related known technology may obscure the gist of the present disclosure, the detailed description thereof is omitted.

Terms such as first and second may be used to describe various components, but the components are not limited by the terms. The terms are used only to distinguish one component from another.

The terms used in the present disclosure are merely used to describe the specific embodiments and are not intended to limit the present disclosure. As the terms used in the present disclosure, common terms that are currently widely used were selected while considering their functions in the present disclosure, but this may vary depending on the intention of engineers working in the field, precedents, or the emergence of new technologies. In addition, in certain cases, there may be terms arbitrarily selected by the applicant, and in this case, the meaning thereof will be described in detail in the description of the corresponding invention. Therefore, the terms used in the present disclosure should be defined based on the meaning of the term and the overall content of the present disclosure, rather than simply the name of the term.

Singular expressions include plural expressions, unless the context clearly indicates otherwise. In the present disclosure, it should be understood that terms such as “comprise” or “have” are intended to specify the existence of features, numbers, steps, operations, components, parts described herein, or combinations thereof, and do not exclude in advance presence or addition of one or more other features, numbers, steps, operations, components, parts, or combinations thereof.

### REFERENCE NUMERALS

10: mobile robot
100: reference local path planning apparatus
110: memory
120: processor

### MODE

Hereinafter, embodiments of the present disclosure will be described in detail with reference to the attached drawings. In the description with reference to the accompanying drawings, components identical to or corresponding to each other will be assigned the same reference numerals and redundant description thereof will be omitted.

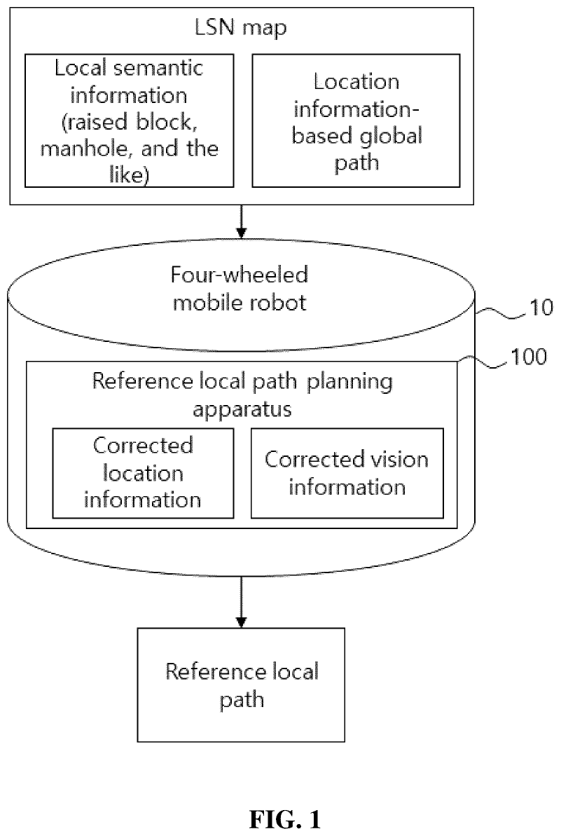

FIG. 1 is a diagram illustrating a reference local path planning operation in a mobile robot in which an apparatus for planning a reference local path in a local semantic navigation map is implemented, according to an embodiment of the present disclosure.

As shown in FIG. 1, an apparatus 100 for planning a reference local path in a local semantic navigation map according to an embodiment of the present disclosure may be implemented in a mobile robot 10. In this regard, the mobile robot 10 may include any type of robot that may travel in an autonomous or non-autonomous manner on a path or in a section from current location coordinates to destination coordinates, and may not be limited to a specific mobile robot.

A local semantic navigation map (LSN) may be constructed in advance. The local semantic navigation map stores local semantic information (e.g., a raised block, a manhole, and the like) and a location information-based global path. In this regard, the LSN map represents a navigation map containing semantic information that may be recognized by a camera of the mobile robot 10 for the travel. For example, such a navigation map may contain the local semantic information that is recognized by the mobile robot 10 and enables safe and reliable travel thereof, like a lane of a vehicle.

Various semantic information for the travel of the mobile robot at a specific location may be integrated into the LSN map before the travel. The LSN map constructed with various semantic information at a specific location may be matched with semantic information at the specific location that the mobile robot may recognize when traveling. Therefore, when even one travel type is matched, the reference local path planning apparatus 100 may update location information as the mobile robot travels with the matched recognition information.

The reference local path planning apparatus 100 matches travel information in the pre-constructed LSN map with current location information and extracts various types of travel information from the stored LSN map. In this regard, the various types of travel information may include various types of semantic information that may play a role like the lane of the vehicle in travel of the robot on a sidewalk, in an alley, and the like.

Further, the reference local path planning apparatus 100 type-matches the various types of extracted travel information with a travel area recognized from a vision sensor.

Next, the reference local path planning apparatus 100 extracts candidate paths of the matched travel areas and a candidate path at the mobile robot location and determines reliability of the paths for the extracted candidate paths. Additionally, the reference local path planning apparatus 100 may determine reliability of a reference local path obtained via the location information depending on a degree to which accuracy of the location information may be followed.

However, when the reliability of the above candidate paths is not sufficient to follow, the reference local path planning apparatus 100 may use the location information of the mobile robot 10 and the global path to derive the reference local path and follow the same as a travel section of the mobile robot 10.

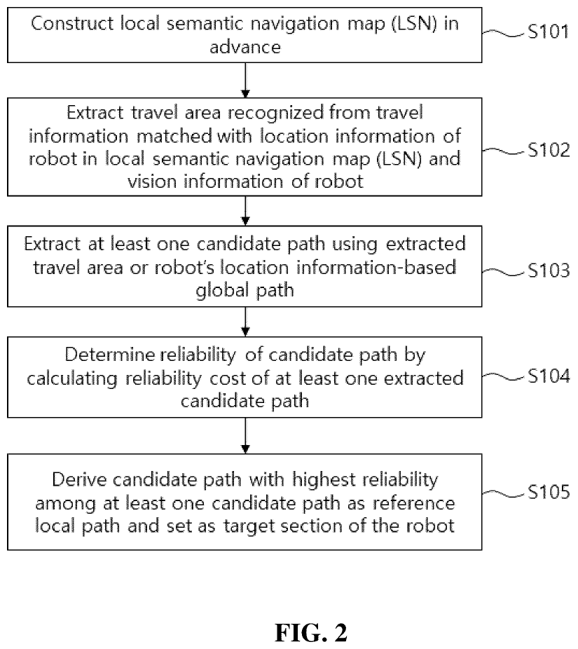

FIG. 2 is a flowchart of a method for planning a reference local path in a local semantic navigation map, according to an embodiment of the present disclosure.

In step S101, the reference local path planning apparatus 100 according to an embodiment of the present disclosure constructs the local semantic navigation map (LSN) in advance.

In step S102, the reference local path planning apparatus 100 according to an embodiment of the present disclosure extracts the travel area recognized from the travel information matched with the location information of the robot in the local semantic navigation map (LSN) and vision information of the robot.

In step S103, the reference local path planning apparatus 100 according to an embodiment of the present disclosure extracts at least one candidate path using the extracted travel area or the robot's location information-based global path.

In step S104, the reference local path planning apparatus 100 according to an embodiment of the present disclosure determines the reliability of the candidate path by calculating a reliability cost of the at least one extracted candidate path.

In step S105, the reference local path planning apparatus 100 according to an embodiment of the present disclosure derives a candidate path with the highest reliability among the determined at least one candidate path as the reference local path and sets the same as a target section of the robot.

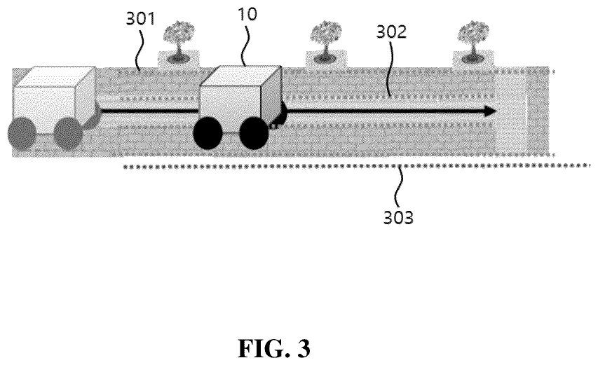

FIG. 3 is a diagram for illustrating an operation of deriving a reference local path in a local semantic navigation map, according to an embodiment of the present disclosure.

On a road on which the mobile robot 10 is traveling shown in FIG. 3, a green line 301 represents an edge of a sidewalk, a blue line 302 represents an edge of a raised block, and a red line 303 represents a global path recognized with location information.

The operation of deriving the reference local path in the local semantic navigation map according to an embodiment of the present disclosure will be described.

The reference local path planning apparatus 100 measures accuracy and precision of the post-processed location information and then determines whether a location error is small enough to travel with confidence in the location information. Thereafter, the reference local path planning apparatus 100 may assign a score to a candidate path, which uses the global path recognized with the location information.

In addition, the reference local path planning apparatus 100 stores the location information and types of local semantic information available at a current location in a pre-created LSN map.

The reference local path planning apparatus 100 type-matches travel areas recognized by the vision sensor with the stored local semantic information.

Subsequently, the reference local path planning apparatus 100 may derive edges that secure as many pixels as possible for the matched travel areas via polynomial random sampling. In this regard, the random sampling may operate by utilizing the local information of the mobile robot 10 and a coefficient meaning of a polynomial of the global path, and the reference local path planning apparatus 100 may assign the scores to the candidate paths of the extracted edges.

The reference local path planning apparatus 100 reconstructs the scores via the local information of the mobile robot 10, utilizes the reconstructed scores to differentiate the reliability, and derives a polynomial with the highest reliability. In this regard, utilizing the score reconstruction to differentiate the reliability and deriving the polynomial with the highest reliability means that the reference local path planning apparatus 100 compares Euclidean distances of respective candidate paths to the mobile robot 10 to each other, weights a reliability cost, and selects a candidate path with the highest weight.

In one example, when there is no reliable polynomial, the reference local path planning apparatus 100 may reconstruct the polynomial with the local information of the robot and the global information. When the extracted candidate path is difficult to use because the number of points used is insufficient or the distance from the robot is too great, the reference local path planning apparatus 100 may use the candidate path extracted from the mobile robot 10 as the reference local path.

The reference local path planning apparatus 100 may calculate the score of the candidate path by considering coefficients of the polynomial and a spacing policy derived at a certain time interval from a surrounding object. The reference local path planning apparatus 100 may calculate the score of the candidate path by considering the spacing policy with respect to the surrounding object at the certain time interval. In this regard, a required spacing is the product of a length of the robot in a direction to the surrounding object from the mobile robot, a required time, and a speed in the direction to the surrounding object. The corresponding spacing policy may represent a sum of a spacing between the mobile robot and the corresponding object and the required spacing in the direction of the surrounding object.

The reference local path planning apparatus 100 induces the travel of the mobile robot 10 to the reference local path, which is the polynomial derived via such process.

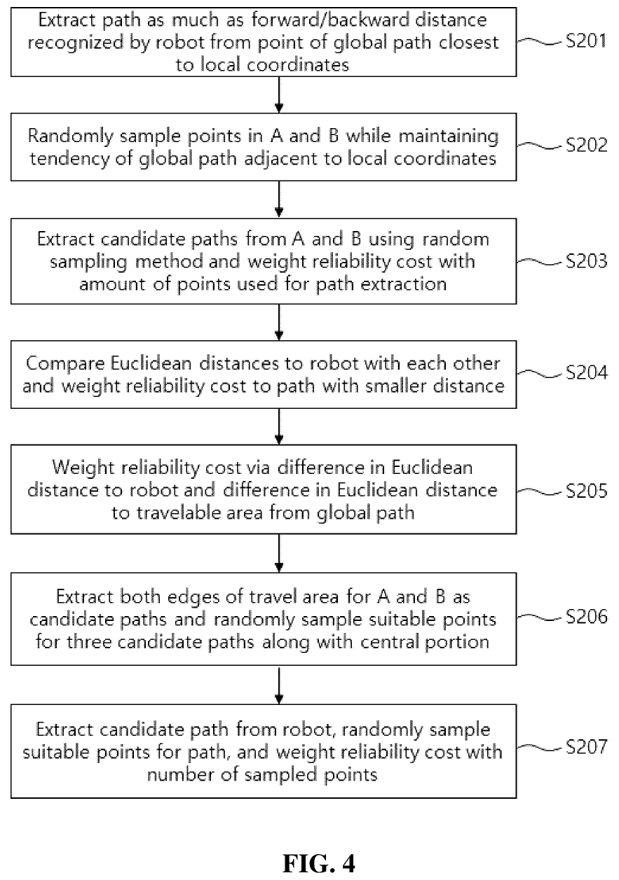

FIG. 4 is a diagram illustrating a recognition performance evaluation method when a type is matched at a specific location while a mobile robot is traveling in an embodiment of the present disclosure.

First, it is assumed that types of class A and class B are matched with each other at the specific location while the mobile robot 10 is traveling. In this regard, the reference local path planning apparatus 100 may evaluate reliability of recognition performances of the class A and the class B. The corresponding evaluation may proceed as shown in FIG. 4.

In step S201, the reference local path planning apparatus 100 first extracts a path as much as a forward/backward distance recognized by the mobile robot 10 from a point of the global path closest to the local coordinates of the mobile robot 10.

In step S202, the reference local path planning apparatus 100 randomly samples points in the class A and the class B while maintaining a tendency of the global path adjacent to the local coordinates. In this regard, the reference local path planning apparatus 100 may weight a reliability cost to a type with the more points sampled. The reference local path planning apparatus 100 may only evaluate the reliability of the travel area without extracting the candidate path.

In step S203, the reference local path planning apparatus 100 extracts the candidate paths from the class A and the class B using the random sampling method and weights the reliability cost with the amount of points used for the path extraction. The reference local path planning apparatus 100 may extract the candidate paths via the location information, the local semantic information, and the vision information. In this regard, the number of candidate paths extracted from the A and the B is not limited. The reference local path planning apparatus 100 may extract at least one reliable candidate path.

In step S204, the reference local path planning apparatus 100 compares the Euclidean distances to the mobile robot 10 with each other and weights the reliability cost to a path with the smaller distance.

In step S205, the reference local path planning apparatus 100 weights the reliability cost via a difference in the Euclidean distance to the robot and a difference in a Euclidean distance to the travelable area from the global path. In addition, the reference local path planning apparatus 100 may weight the reliability cost by randomly sampling global path curve information from the travelable area and storing the number of points. The reference local path planning apparatus 100 may extract one candidate path via the global path in step S203.

In step S206, the reference local path planning apparatus 100 extracts both edges of the travel area for the class A and the class B as the candidate paths and randomly samples suitable points for three candidate paths along with a central portion. Thereafter, the reference local path planning apparatus 100 may weight the reliability cost with the number of points. The reference local path planning apparatus 100 may extract the three candidate paths from the both edges and the central portion based on local coordinates of the area reliable throughout the A and the B in step S204. In this regard, the reference local path planning apparatus 100 may derive the edges that secure as many pixels as possible with the polynomial random sampling. This refers to comparing the number of points used when extracting the edge candidate paths, weighting the reliability cost with the comparison result, and extracting the candidate path with the highest weight.

In step S207, the reference local path planning apparatus 100 extracts the candidate path from the mobile robot 10 and randomly samples the suitable points for the candidate path. The reference local path planning apparatus 100 may weight the reliability cost with the number of sampled points. The reference local path planning apparatus 100 may extract one candidate path from the mobile robot 10.

As such, the reference local path planning apparatus 100 may determine the reliability via steps S201 to S205. In this regard, the reference local path planning apparatus 100 may extract all the candidate paths while maintaining the tendency of the global path close to the local coordinates. The reference local path planning apparatus 100 may perform the random sampling while maintaining the tendency of the global path.

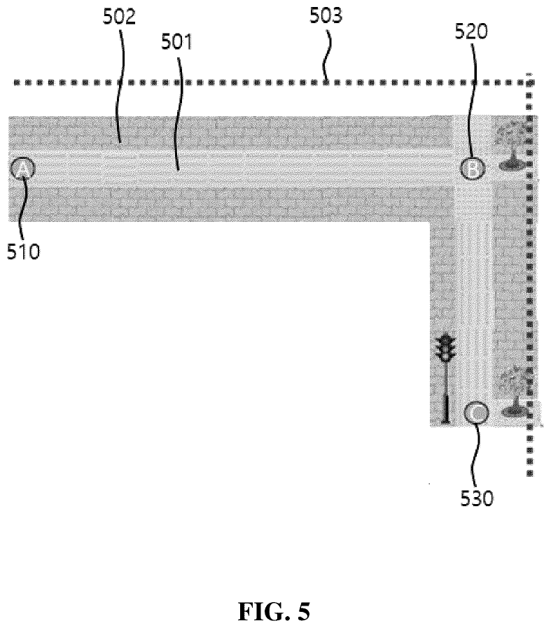

FIGS. 5 to 8 are diagrams showing a process example of a method for planning a reference local path in a local semantic navigation map, according to an embodiment of the present disclosure.

As shown in FIG. 5, the reference local path planning apparatus 100 constructs the local navigation map for the autonomous driving in advance. An example of the reference local path planning method will be described assuming that the mobile robot 10 travels from a section A to a section C.

For example, in FIG. 5, the navigation map includes a node A 510, a node B 520, and a node C 530. The navigation map contains a raised block 501, a sidewalk block 502, and a global path 503, which is a red dotted line.

Node A information includes location information and a learned semantic travel area. The location information of the node A includes a latitude value of 37.548030 and a longitude value of 127.044344. The learned semantic travel area of the node A includes the raised block (end node) and the sidewalk block (end node).

Node B information includes location information and a learned semantic travel area. The location information of the node B includes a latitude value of 37.545263 and a longitude value of 127.044612. The learned semantic travel area of the node B includes the raised block (end node), a street tree, and sidewalk block (way).

Node C information includes location information and a learned semantic travel area. The location information of the node C includes a latitude value of 37.545245 and a longitude value of 127.044710. The learned semantic travel area of the node C includes the raised block (way), a traffic light, and the sidewalk block (end node).

In this regard, the end node represents an end of continuous semantic information, the way represents a portion other than the end of the continuous semantic information, and the red dotted line represents the global path.

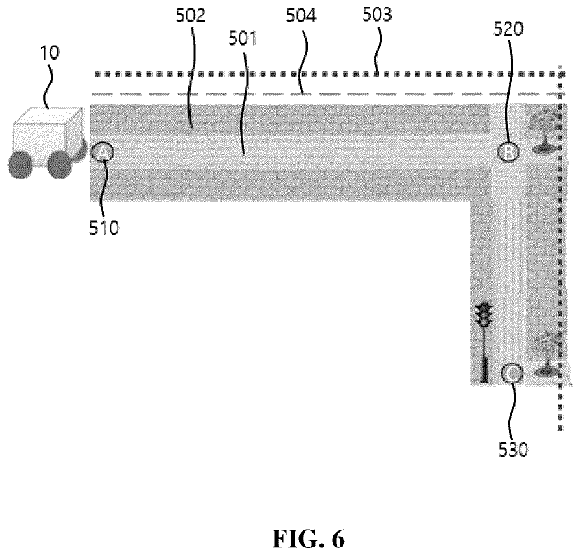

As shown in FIG. 6, the reference local path planning apparatus 100 matches it with the location information of the mobile robot 10 and extracts at least one type of travel information from the navigation map constructed in advance and stored.

Referring to FIG. 6, an example of the matching operation of the location information and the operation of extracting the travel information will be described assuming that the mobile robot 10 travels from the section A to the section C.

In FIG. 6, the navigation map where the mobile robot 10 travels includes the node A 510, node B 520, and node C 530. The navigation map includes the raised block 501, the sidewalk block 502, the global path 503, which is the red dotted line, and an orange lane 504.

The node A information includes the location information and the learned semantic travel area. The location information of the node A includes the latitude value of 37.548030 and the longitude value of 127.044344. The learned semantic travel area of the node A includes the raised block (end node) and the sidewalk block (end node).

The node B information includes the location information and the learned semantic travel area. The location information of the node B includes the latitude value of 37.545263 and the longitude value of 127.044612. The learned semantic travel area of the node B includes the raised block (end node), the street tree, and the sidewalk block (way).

The node C information includes the location information and the learned semantic travel area. The location information of the node C includes the latitude value of 37.545245 and the longitude value of 127.044710. The learned semantic travel area of the node C includes the raised block (way), the traffic light, and the sidewalk block (end node).

In FIG. 6, measured area coordinates of the mobile robot 10 may be a latitude value of 37.548030 and a longitude value of 127.044343.

In this regard, the reference local path planning apparatus 100 performs the location information matching of the mobile robot 10. The reference local path planning apparatus 100 matches the local coordinates of the mobile robot 10 to the closest node by calculating Euclidean distances to the location information of the node A, the node B, and the node C. In FIG. 6, the reference local path planning apparatus 100 may perform the location information matching to the node A closest to the local coordinates of the mobile robot 10.

Further, the reference local path planning apparatus 100 matches the learned semantic travel area in the navigation map. For example, the reference local path planning apparatus 100 may match the raised block (end node) and the sidewalk block (end node), which are the semantic travel areas learned at the node A, which is closest to the mobile robot 10.

In this regard, the reference local path planning apparatus 100 may match a labeled semantic travel area (e.g., the orange lane) that has not been integrated into the navigation map. Subsequently, the reference local path planning apparatus 100 may build the local semantic navigation map via a construction request alarm.

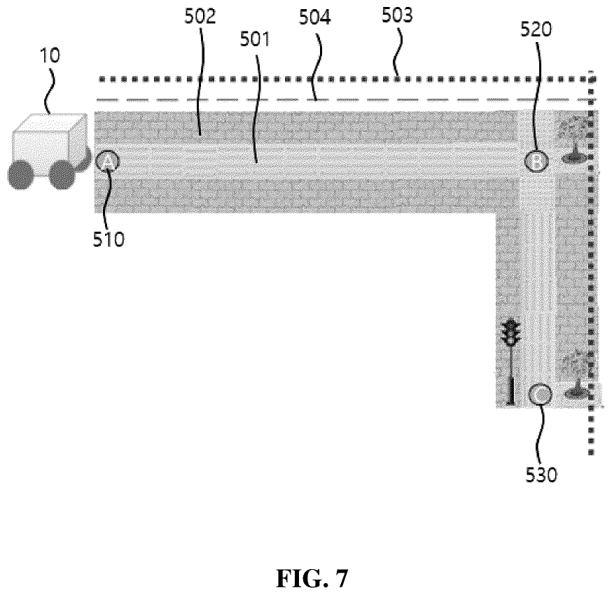

As shown in FIG. 7, the reference local path planning apparatus 100 determines the reliability of the candidate paths extracted from the semantic travel area.

Referring to FIG. 7, an example of the operation of determining the reliability of the candidate paths extracted from the semantic travel area will be described assuming that the mobile robot 10 travels from the section A to the section C.

In FIG. 7, the navigation map where the mobile robot 10 travels includes the node A 510, the node B 520, and the node C 530. The navigation map includes the raised block 501, the sidewalk block 502, the global path 503, which is the red dotted, and the orange lane 504.

The node A information includes the location information and the learned semantic travel area. The location information of the node A includes the latitude value of 37.548030 and the longitude value of 127.044344. The learned semantic travel area of the node A includes the raised block (end node) and the sidewalk block (end node).

The node B information includes the location information and the learned semantic travel area. The location information of the node B includes the latitude value of 37.545263 and the longitude value of 127.044612. The learned semantic travel area of the node B includes the raised block (end node), the street tree, and the sidewalk block (way).

The node C information includes the location information and the learned semantic travel area. The location information of the node C includes the latitude value of 37.545245 and the longitude value of 127.044710. The learned semantic travel area of the node C includes the raised block (way), the traffic light, and the sidewalk block (end node).

In FIG. 7, the measured area coordinates of the mobile robot 10 may be the latitude value of 37.548030 and the longitude value of 127.044343.

In this regard, the reference local path planning apparatus 100 may derive candidate paths (e.g., third-order polynomials or the like) for edges and a central portion of each of the various learned semantic travel areas. In this regard, the path may be derived as the third-order polynomial.

For example, the reference local path planning apparatus 100 may derive third-order polynomials of the edges and the central portion of each of the raised block and the sidewalk block as the candidate paths in the travel situation in FIG. 7.

Further, the reference local path planning apparatus 100 may derive the third-order polynomials of the edges and the central portion of each of the various learned semantic travel areas, and derive the third-order polynomial based on the local coordinates of the mobile robot 10 and the third-order polynomial based on the global path.

Subsequently, the reference local path planning apparatus 100 may calculate a cost function for each of the derived third-order polynomials and derive the third-order polynomial with the highest reliability.

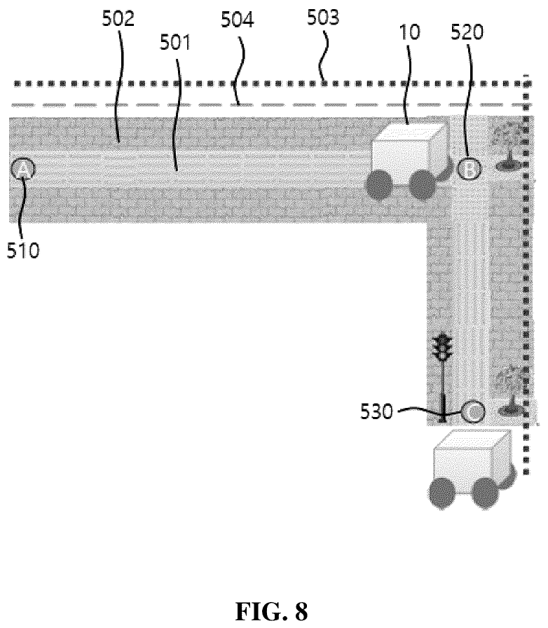

As shown in FIG. 8, the reference local path planning apparatus 100 may set a target section of the mobile robot 10 by calculating the path with the highest reliability each time. Accordingly, the mobile robot 10 may travel based on the set target section.

Referring to FIG. 8, an example of the operation of setting the target section of the mobile robot 10 by calculating the path with the highest reliability each time will be described assuming that the mobile robot 10 travels from the section A to the section C.

In FIG. 8, the navigation map where the mobile robot 10 travels includes the node A 510, the node B 520, and the node C 530. The navigation map includes the raised block 501, the sidewalk block 502, the global path 503, which is the red dotted, and the orange lane 504.

The node A information includes the location information and the learned semantic travel area. The location information of the node A includes the latitude value of 37.548030 and the longitude value of 127.044344. The learned semantic travel area of the node A includes the raised block (end node) and the sidewalk block (end node).

The node B information includes the location information and the learned semantic travel area. The location information of the node B includes the latitude value of 37.545263 and the longitude value of 127.044612. The learned semantic travel area of the node B includes the raised block (end node), the street tree, and the sidewalk block (way).

The node C information includes the location information and the learned semantic travel area. The location information of the node C includes the latitude value of 37.545245 and the longitude value of 127.044710. The learned semantic travel area of the node C includes the raised block (way), the traffic light, and the sidewalk block (end node).

In FIG. 8, the measured area coordinates of the mobile robot 10 may be the latitude value of 37.548030 and the longitude value of 127.044343.

In this regard, the reference local path planning apparatus 100 derives third-order polynomials for edges and a central portion of each of the various learned semantic travel areas. For example, the reference local path planning apparatus 100 may derive the third-order polynomials for the edges and the central portion of each of the street tree, the raised block, and the sidewalk block in the travel situation shown in FIG. 8.

Thereafter, the reference local path planning apparatus 100 may repeat such process each time to set the target section of the mobile robot 10 from the section A to the section C via the section B. Accordingly, the mobile robot 10 may travel from the section A to the section C.

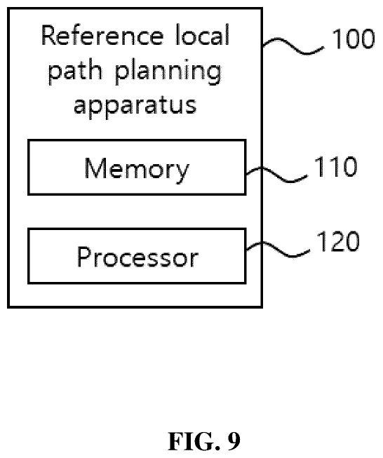

FIG. 9 is a configuration diagram of an apparatus for planning a reference local path in a local semantic navigation map, according to an embodiment of the present disclosure.

As shown in FIG. 9, in the local semantic navigation map according to an embodiment of the present disclosure, the reference local path planning apparatus 100 includes a memory 110 and a processor 120. In this regard, the reference local path planning apparatus 100 may obtain the location information and the vision information from the location sensor and the vision sensor. Alternatively, the reference local path planning apparatus 100 may further include the location sensor or the vision sensor that senses the location information and the vision information. However, not all of the illustrated components are essential components. The reference local path planning apparatus 100 may be implemented with more components than the illustrated components or the reference local path planning apparatus 100 may be implemented with fewer components than the illustrated components.

Hereinafter, a specific configuration and an operation of each component of the reference local path planning apparatus 100 in FIG. 9 will be described.

The memory 110 stores one or more programs related to the reference local path planning operation in the local semantic navigation map.

The processor 120 executes the one or more programs stored in the memory 110. The processor 120 extracts a travel area recognized from travel information matched with location information of a robot in the local semantic navigation map and vision information of the robot, extracts at least one candidate path using the extracted travel area or a robot's location information-based global path, determines reliability of each candidate path by calculating a reliability cost of each of the extracted at least one candidate path, and derives a candidate path with the highest reliability among the determined at least one candidate path as the reference local path and sets the derived reference local path as a target section of the robot.

According to embodiments, the processor 120 may update the navigation map using labeled local semantic information that has not been integrated.

According to embodiments, the processor 120 may extract the candidate path while maintaining tendency of the global path close to local coordinates of the robot.

According to embodiments, the processor 120 may extract the respective candidate paths for both edges and a central portion from the extracted travel area.

According to embodiments, the processor 120 may extract the candidate path from the robot when the extracted candidate path has the number of used points smaller than a preset threshold number or has a distance from the robot greater than a preset threshold distance.

According to embodiments, the processor 120 may weight the reliability cost for each of the extracted at least one candidate path based on the number of points used to extract each of the at least one candidate path.

According to embodiments, the processor 120 may weight the reliability cost for each of the extracted at least one candidate path based on a distance from the robot.

According to embodiments, the processor 120 may derive the reference local path using the location information of the robot and the global path when the determined reliability of the at least one candidate path is smaller than a preset threshold.

As such, the reference local path planning apparatus 100 according to the embodiment of the present disclosure may extract the reference local path using the data extracted via the local sensor of the mobile robot, thereby performing robust and continuous lateral control of the mobile robot in a safer and more continuous manner than the scheme of extracting and controlling the reference local path only via the location information processed via the global sensor such as the global positioning system (GPS), the inertial measurement unit (IMU), and the like.

The reference local path planning apparatus 100 according to the embodiment of the present disclosure may solve problems caused by a location error in a shaded area, a recognition error of the vision information, and the like, and control the travel robustly and smoothly even in a specific urban area or with occasionally derived low-accuracy recognition results. As such, the reference local path planning apparatus 100 may perform general-purpose autonomous driving that does not depend on high-accuracy location information and recognition results.

The reference local path planning apparatus 100 according to the embodiment of the present disclosure may derive the reference local path using the vision information recognized via the information obtained from the vision sensor relatively inexpensive compared to the Lidar and the location information obtained via the low-cost GPS and IMU, thereby reducing the unit cost of the mobile robot.

According to an embodiment of the present disclosure, the various embodiments described above may be implemented with software including instructions stored in a machine (e.g., computer-readable storage medium. The machine, as a machine that may call the stored instructions from the storage medium and operate based on the called instructions, may include an electronic device (e.g., an electronic device A) according to the disclosed embodiments. When a command is executed by a processor, a function corresponding to the instruction may be performed directly by the processor or using other components under control of the processor. The command may contain code generated or executed by a compiler or an interpreter. The machine-readable storage medium may be provided in a form of a non-transitory storage medium. In this regard, the ‘non-transitory’ only means that the storage medium does not contain signals and is tangible, and does not distinguish whether the data is stored semi-permanently or temporarily in the storage medium.

Additionally, according to an embodiment of the present disclosure, the method according to the various embodiments described above may be provided by being included in a computer program product. The computer program product, as a commodity, may be traded between a seller and a buyer. The computer program product may be distributed in the form of the machine-readable storage medium (e.g., a compact disc read only memory (CD-ROM)) or online via an application store (e.g., Play Store™). In the case of online distribution, at least a portion of the computer program product may be at least temporarily stored or created temporarily in a storage medium such as a memory of a manufacturer's server, an application store's server, or a relay server.

In addition, according to an embodiment of the present disclosure, the various embodiments described above may be implemented in a recording medium that may be read by the computer or a device similar thereto using software, hardware, or a combination thereof. In some cases, the embodiments described herein may be implemented in the processor itself. According to the software implementation, the embodiments such as the procedures and the functions described herein may be implemented with separate software modules. Each of the software modules may perform the one or more functions and operations described herein.

In one example, computer instructions for performing a processing operation of a device according to the various embodiments described above may be stored in a non-transitory computer-readable medium. The computer instructions stored in such non-transitory computer-readable medium, when executed by a processor of a specific device, causes the specific device to perform the processing operation in the device according to the various embodiments described above. The non-transitory computer-readable medium refers to a medium that may store data semi-permanently and may be read by the machine, rather than a medium that stores the data for a short period of time, such as a register, a cache, and a memory. Specific examples of the non-transitory computer-readable media may include a CD, a DVD, a hard disk, a Blu-ray disk, a USB, a memory card, ROM, and the like.

In addition, each component (e.g., a module or a program) according to the various embodiments described above may be composed of a single entity or a plurality of entities, and some of the corresponding sub-components described above may be omitted or other subcomponents may be further included in the various embodiments. Alternatively or additionally, some components (e.g., modules or programs) may be integrated into a single entity and perform the functions performed by the respective corresponding components prior to the integration in the same or similar manner. Operations performed by the module, the program, or other components according to the various embodiments may be executed sequentially, in parallel, iteratively, or heuristically, at least some operations may be executed in a different order, omitted, or other operations may be added.

Hereinabove, the preferred embodiment of the present disclosure has been shown and described, but the present disclosure is not limited to the specific embodiment described above. Further, various modifications may be made by those skilled in the art without departing from the gist of the present disclosure as claimed in the claims, and such modifications should not be understood individually from the technical ideas or perspectives of the present disclosure.

### INDUSTRIAL APPLICABILITY

It may be used in a robot industry, and specifically in a method, an apparatus, and the like for traveling of a robot.

1. A method for planning a reference local path in a local semantic navigation map performed by a reference local path planning apparatus, the method comprising:
extracting a travel area recognized from travel information matched with location information of a robot in a local semantic navigation map (LSN) and vision information of the robot;
extracting at least one candidate path using the extracted travel area or a robot's location information-based global path;
determining reliability of each candidate path by calculating a reliability cost of each of the extracted at least one candidate path; and
deriving a candidate path with the highest reliability among the determined at least one candidate path as the reference local path and setting the derived reference local path as a target section of the robot.

2. The method of claim 1, further comprising:
updating the navigation map using labeled local semantic information that has not been integrated.

3. The method of claim 1, wherein the extracting of the candidate path includes:
extracting the candidate path while maintaining tendency of the global path close to local coordinates of the robot.

4. The method of claim 1, wherein the extracting of the candidate path includes:
extracting the respective candidate paths for both edges and a central portion from the extracted travel area.

5. The method of claim 1, wherein the extracting of the candidate path includes:
extracting the candidate path from the robot when the extracted candidate path has the number of used points smaller than a preset threshold number or has a distance from the robot greater than a preset threshold distance.

6. The method of claim 1, wherein the determining of the reliability of each candidate path includes:
weighting the reliability cost for each of the extracted at least one candidate path based on the number of points used to extract each of the at least one candidate path.

7. The method of claim 1, wherein the determining of the reliability of each candidate path includes:
weighting the reliability cost for each of the extracted at least one candidate path based on a distance from the robot.

8. The method of claim 1, further comprising:
deriving the reference local path using the location information of the robot and the global path when the determined reliability of the at least one candidate path is smaller than a preset threshold.

9. An apparatus for planning a reference local path in a local semantic navigation map, the apparatus comprising:
a memory configured to store one or more programs; and
a processor configured to execute the one or more stored programs,
wherein the processor is configured to:
extract a travel area recognized from travel information matched with location information of a robot in the local semantic navigation map and vision information of the robot;
extract at least one candidate path using the extracted travel area or a robot's location information-based global path;
determine reliability of each candidate path by calculating a reliability cost of each of the extracted at least one candidate path; and
derive a candidate path with the highest reliability among the determined at least one candidate path as the reference local path and set the derived reference local path as a target section of the robot.

10. The apparatus of claim 9, wherein the processor is configured to update the navigation map using labeled local semantic information that has not been integrated.

11. The apparatus of claim 9, wherein the processor is configured to extract the candidate path while maintaining tendency of the global path close to local coordinates of the robot.

12. The apparatus of claim 9, wherein the processor is configured to extract the respective candidate paths for both edges and a central portion from the extracted travel area.

13. The apparatus of claim 9, wherein the processor is configured to extract the candidate path from the robot when the extracted candidate path has the number of used points smaller than a preset threshold number or has a distance from the robot greater than a preset threshold distance.

14. The apparatus of claim 9, wherein the processor is configured to weight the reliability cost for each of the extracted at least one candidate path based on the number of points used to extract each of the at least one candidate path.

15. The apparatus of claim 9, wherein the processor is configured to weight the reliability cost for each of the extracted at least one candidate path based on a distance from the robot.

16. The apparatus of claim 9, wherein the processor is configured to derive the reference local path using the location information of the robot and the global path when the determined reliability of the at least one candidate path is smaller than a preset threshold.
